(19) United States
(12) Patent Application Publication
(10) Pub. No.: US 2008/0113133 A1
(43) Pub. Date: May 15, 2008

(54) Transparent Deep Drawn Anti-Fog Films

(75) Inventors: Tobias Fackler, Legau (DE); Christoph Schweitzer, Obergunzburg (DE); Walter Bernig, Durach (DE); Bernard Dujardin, Brussel (BE)

Correspondence Address: NORRIS, MCLAUGHLIN & MARCUS, P.A., 875 THIRD AVE, 18TH FLOOR, NEW YORK, NY, 10022, US

(73) Assignee: CFS KEMPTEN GmbH, Kempten (DE)

(21) Appl. No.: 11/719,268

(22) PCT Filed: Nov. 16, 2005
(86) PCT No.: PCT/EP05/56024

§ 371 Date: Jul. 31, 2007

(30) Foreign Application Priority Data
Nov. 16, 2004 (DE) 10 2004 055 323.8

(51) Int. Cl. B32B 3/00; B32B 7/12; B32B 27/08

(52) U.S. Cl. 428/35.7; 428/203; 428/200

(57) ABSTRACT

Deep drawn transparent thermoplastic polymeric film having anti-fog properties, useful for packaging moisture releasing products, such as foods.

The invention relates to a transparent, thermoformable film, which is suitable for packaging goods which contain moisture, in particular foodstuffs. The film according to the invention may be of a single layer or multilayer structure.

Foodstuffs packaging known under the name “MAP packaging” (modified atmosphere packaging) is used increasingly widely, for example for the packaging of fresh meat.

Known packaging of this type consists of two packaging elements, between which the product to be packaged is arranged. The first packaging element is generally shaped into a tray, i.e. a deep, dished shape, which accommodates the product to be packaged. Such trays are conventionally shaped by thermoforming of suitable films. To close the packaging, the tray is covered by the second packaging element, which acts in the manner of a lid, so producing a closed space therebetween in which the product to be packaged is located. The two packaging elements are joined together by means of a peripheral heat-sealing (welding) rim, the space therebetween preferably being filled with a protective gas atmosphere before the sealing operation. The material, which forms the first packaging element (tray), has to have a certain mechanical strength and dimensional stability in the temperature range conventional for the particular application, so that the packaging offers satisfactory protection for the packaged product during transport and storage. The material which forms the second packaging element (lid) is usually transparent, such that the packaged product located thereunder is readily visible.

A disadvantageous feature of such packaging is that the product, which per se is readily visible through the transparent lid, is in practice at least partially obscured by the label which is subsequently to be stuck on and the price tag. Such packaging furthermore has the disadvantage that the packaged product can be observed from only one side, as the material forming the tray is usually not transparent. This impairs the purpose of such packaging, namely permitting the completest possible monitoring of the product. A regular monitoring of the product is necessary so that the freshness and quality of the packaged product may be verified, which is in particular important in the case of perishable foodstuffs. Furthermore, visibility of the packaged product allows good presentation of the product.

In order to ensure effective monitoring of the packaged product also from the rear side, packaging has been developed in which not only the lid, but also the tray is transparent.

Numerous packaged products, in particular also foodstuffs, have the characteristic of containing a relatively high proportion of moisture, in particular water. Over the course of storage, a certain quantity of water vapour is as a rule released into the space between packaged product and packaging. It must be borne in mind in this connection that, despite compliance with the cold chain which is sometimes required, the packaged product is exposed to a certain degree of temperature fluctuation, as a result of which the water vapour present in this space may reach the dew point and condense. As a consequence, small water droplets are deposited not only on the packaged product, but also on the interior surface of the packaging. The result is droplet formation and fogging over the entire surface of the packaging facing the packaged product. However, if the packaging material is transparent in at least some areas, the droplet formation and fogging severely impairs the visibility of the packaged product. Furthermore, in the case of food packaging, the appearance of the packaged foodstuff as a result of fogging and droplet formation no longer provides the impression of the freshness desired by the purchaser.

Comparatively thin films are known in the prior art which are suitable inter alia for packaging foodstuffs and which are designed such that they suppress the formation of droplets and fogging on their surface. These films may, for example, be coated with an additive with antifogging properties or contain an additive with antifogging properties. Reference may be made in this connection, for example, to U.S. Pat. No. 5,766,772.

However, prior art films in which droplet formation and fogging is suppressed are not thermoformable. If trays were to be thermoformed using such films, these trays would not be suitable for accommodating packaged products, as the mechanical properties of the films are not sufficient to ensure adequate rigidity and flexural strength of the packaging. The films known in the prior art are thus at most suitable for use as a lid.

The requirements made of a packaging material which is thermoformable, i.e. is suitable for forming a tray, are multi-faceted. On the one hand, the packaging material has to be readily processable, i.e. it has to be capable of quick, reliable processing using conventional thermoforming units, while on the other hand it has to display satisfactory rigidity only a short time after the thermoforming process, so as not to lose the predetermined tray shape after leaving the thermoforming unit. In addition, at least the surface of the packaging material facing the inside of the tray needs to be heat-sealable, so that subsequently, after the introduction of the product to be packaged, the packaging may be closed in airtight manner by sealing (welding) the lid to the tray. Furthermore, the packaging material used must satisfy the toxicity standards relating to the packaging of foodstuffs.

Particular difficulties arise if, in addition to the above-stated properties, the packaging material from which the tray is shaped by thermoforming is also intended to be transparent so that the packaged product may also be observed from the underside of the packaging, i.e. through the material forming the tray, so enabling monitoring of its condition.

Since thermoformable packaging materials suitable for the formation of trays often exhibit a distinctly greater layer thickness in comparison with the materials suitable for lids, the requirements with regard to optical properties are incomparably higher, as the light must cover a distinctly greater distance through the packaging material of the tray than is the case for the lid. While the layer thickness of the materials forming the lid is frequently in the range from 5 to 50 μm, thermoformable packaging materials frequently exhibit layer thicknesses of 200 μm and above due to the mechanical properties which are required. In order to satisfy the stringent requirements which generally apply to foodstuffs packaging, the thermoformable packaging material suitable for forming trays must exhibit a high level of transparency, without mechanical properties consequently being impaired,

If fogging and droplet formation on the surface of the tray facing the packaged product are now also to be suppressed, neither the mechanical nor the optical properties of the thermoformable packaging material nay be impaired as a consequence.

There is therefore a need for a transparent packaging material which has advantages over the materials of the prior art.

The object of the invention is accordingly to provide an improved packaging material which permits monitoring of the packaged product. In particular, the packaging material should be transparent, thermoformable and thus suitable for forming packaging trays for foodstuffs, while satisfying high standards with regard to mechanical strength and optical transparency. Fogging and droplet formation should be suppressed to such an extent that the visibility of the packaged product through the material which forms the tray is not impaired. This suppression of fogging and droplet formation should also be retained when the thermoformable packaging material is subjected to heat treatment as part of the processing thereof or for other reasons, for example for sterilising the packaged product.

This object is achieved by the subject matter of the claims.

It has been found that specific transparent, thermoformable films are suitable for forming MAP packaging trays, wherein an additive with antifogging properties prevents fogging and droplet formation such that the packaged product may be observed and monitored without hindrance through the film which forms the transparent tray. The thermoformable films according to the invention exhibit good mechanical and optical properties, are suitable from a toxicological standpoint for packaging foodstuffs and effectively prevent the condensation of moisture onto the surface thereof.

The invention relates to transparent, thermoformable films, to packaging made therefrom and to the use of the films for packaging products which are to be packaged, in particular foodstuffs.

One aspect of the invention relates to a transparent, thermoformable film comprising a thermoplastic polymer, wherein the film is provided with antifogging properties.

Antifogging properties are preferably imparted to the film with the assistance of an additive with antifogging properties, which is either present in the film or with which at least one surface of the film is coated. For the purposes of the invention, the term “transparent” means that a packaged product may be observed with the naked eye through the thermoformable film. The transparency is preferably quantified with the assistance of densitometers. Such methods are familiar to a person skilled in the art. Preferably, haze (%) may be measured as an optical value as a measure of transparency. Measurement of haze (%) is preferably performed to ASTM test standard D 1003-61 m, procedure A, after calibration of the measuring instrument using haze standards of between 0.3 and 34% haze. An example of a suitable measuring instrument is a haze meter made by Byk-Gardner with an integrating sphere, said haze meter permitting integrated measurement of diffuse light transmittance values over a solid angle of from 8° to 160°. The films according to the invention preferably exhibit haze, determined according to the above-described method, of less than 30%, more preferably less than 25%, still more preferably less than 20%, most preferably less than 15% and in particular less than 12%.

For the purposes of the invention, the term “thermoformable” defines a material which may be “thermoformed” under exposure to heat on a suitable apparatus, i.e. may be shaped under exposure to pressure (and/or a vacuum), for example to yield a tray. The material is a material having thermoplastic properties, such that it is deformable when heated but exhibits sufficient dimensional stability at room temperature, such that the shape (e.g. tray) predetermined by thermoforming is substantially also retained after introduction of the product to be packaged.

The film according to the invention is preferably of multilayer structure. The film according to the invention is preferably not heat-shrinkable, i.e. on exposure to heat the two-dimensional extent of the film is substantially retained and in particular no significant shrinkage occurs within the film plane.

In a preferred embodiment, the film according to the invention comprises a backing layer (T) containing a thermoplastic polymer and an outer heat-sealing layer (S), which preferably contains an additive with antifogging properties or is coated on its free surface with an additive with antifogging properties. If the film according to the invention comprises at least one backing layer (T) and an outer heat-sealing layer (S), the heat-sealing layer (S) is preferably provided with antifogging properties, but preferably not the backing layer (T) or a layer optionally present between the backing layer (T) and the heat-sealing layer (S).

The film according to the invention is preferably asymmetric, i.e. it does not comprise a mirror plane within its layers or at the interface thereof.

Apart from the backing layer (T) and the heat-sealing layer (S), the film according to the invention preferably comprises one or more layers preferably located between the backing layer (T) and the heat-sealing layer (S), which are mutually independently selected from among the group consisting of a bonding layer (V), an interlayer (Z), a coupling agent layer (HV-1), a polyamide layer (PA-1), a barrier layer (B), a polyamide layer (PA-2) and a coupling agent layer (HV-2). In a preferred embodiment, the film according to the invention comprises at least 1 of the above-stated layers preferably located between the backing layer (T) and the polyamide layer (PA-1) or the heat-sealing layer (S), more preferably at least 2, still more preferably at least 3, most preferably at least 4 and in particular at least 5 of the above-stated layers.

Between the backing layer (T) and the beat-sealing layer (S), the film according to the invention preferably contains 1 to 7 layers, more preferably 2 to 7, still more preferably 3 to 7, most preferably 4 to 7 and in particular 5 to 7 layers mutually 5 independently selected from the group consisting of an interlayer (Z), a bonding layer (V), a coupling agent layer (HV-1), a polyamide layer (PA-1), a barrier layer (B), a polyamide layer (PA-2) and a coupling agent layer (IV-2).

The sequence of the individual layers within the film preferably corresponds to the order in which they are stated in the above list, i.e. (T)//(Z)//(V)//(HV-1)//(PA-1)//(B))//(PA-2)//(HV-2)//(S), or (T)//(V)//(Z)//(HV-1)//(PA-1)//(B))//(PA-2)//(HV-2)//(S), wherein “//” marks the interface between two adjacent layers. If, in addition to the layers (T), (PA-1), (B), (PA-2) and (S), the film according to the invention for example contains as the only further layer a bonding layer (V), the sequence of layers in the film is preferably (T)//(V)//(PA-1)//(B)//(PA-2)//(S). It is here not absolutely necessary for two layers separated by “//” to succeed one another directly, i.e. to touch one another—it is also possible for further layers to be inserted. The polyamide layers (PA-1) and (PA-2) and also the coupling agent layers (HV-1) and (HV-2) are in each case mutually independent, i.e. the film according to the invention may, for example, contain a coupling agent layer (HV-2) without simultaneously having to contain a coupling agent layer (HV-1).

The film according to the invention preferably comprises at least the backing layer (T), a heat-sealing layer (S) and a barrier layer (B), wherein the barrier layer (B) is preferably arranged between the backing layer (T) and the heat-sealing layer (S) and the heat-sealing layer (S) is provided with antifogging properties.

Films with the following sequence of layers are particularly preferred, wherein in these preferred embodiments the outer heat-sealing layer (S) is always provided with antifogging properties:

(T)//(S);

(T)//(B)//(S), (T)//(PA-1)//(S), (T)//(Z)//(S), (T)//(HV-1)//(S);

(T)//(PA-1)//(B)//(S), (T)//(B)//(PA-2)//(S), (T)//(HV-1)//(B)//(S),

### (T)//(B)//(HV-2)//(S));

(T)//(PA-1)//(B)//(PA-2)//(S), (T)//(HV-1)//(PA-1)//(B)//(S),

### (T)//(B)//(PA-2)//(HV-2)//(S), (T)//(HV-1)//(B)//(HV-2)//(S),

### (T)//(Z)//(B)//(PA-2)//(S), (T)//(Z)//(PA-1)//(B)//(S), (T)//(Z)//(V)//(B)//(S),

### (T)//(V)//(Z)//(B)//(S);

(T)//(HV-1)//(PA-1)//(B)//(HV-2)//(S),

### (T)//(HV-1)//(B)//(PA-2)//(HV-2)//(S), (T)//(Z)//(V)//(B)//(HV-2)//(S),

### (T)//(V)//(Z)//(B)//(S);

(T)//(HV-1)//(PA-1)//(B)//(HV-2)//(S),

### (T)//(HV-1)//(B)//(PA-2)//(HV-2)//(S), (T)//(Z)//(V)//(B)//(HV-2)//(S),

### (T)//(V)//(Z)//(B)//(HV-2)//(S), (T)//(Z)//(V)//(PA-1)//(B)//(S),

### (T)//(V)//(Z)//(PA-1)//(B)//(S), (T)//(Z)//(HV-1)//(B)//(HV-2)//(S),

### (T)//(HV-1)//(PA-1)//(B)//(PA-2)//(S), (T)//(PA-1)//(B)//(PA-2)//(HV-2)//(S);

(T)//(HV-1)//(PA-1)//(B)//(PA-2)//(HV-2)//(S),

### (T)//(Z)//(V)//(HV-1)//(PA-1)//(B)//(S),

### (T)//(V)//(Z)//(HV-1)//(PA-1)//(B)//(S),

### (T)//(Z)//(V)//(B)//(PA-2)//(HV-2)//(S),

### (T)//(V)//(Z)//(B)//(PA-2)//(HV-2)//(S),

### (T)//(Z)//(V)//(HV-1)//(B)//(HV-2)//(S),

### (T)//(V)//(Z)//(HV-1)//(B)//(HV-2)//(S),

(T)//(Z)//(HV-1)//(PA-1)//(B)//(PA-2)//(HV-2)//(S),

### (T)//(Z)//(V)//(HV-1)//(PA-1)//(B)//(PA-2)//(S),

### (T)//(V)//(Z)//(HV-1)//(PA-1)//(B)//(PA-2)//(S); and

(T)//(Z)//(V)//(HV-1)//(PA-1)//(B)//(PA-2)//(HV-2)//(S),

### (T)//(V)//(Z)//(HV-1)//(PA-1)//(B)//(PA-2)//(HV-2)//(S).

In a preferred embodiment, the film according to the invention exhibits an overall layer thickness of at least 100 pm, more preferably of at least 125 μm, still more preferably of at least 150 μm, most preferably of at least 175 μm and in particular of at least 200 μm. Preferably, the overall layer thickness is in the range from 100 to 3000 μm, more preferably 125 to 2500 μm, still more preferably 150 to 1500 μm, most preferably 175 to 1200 μm and in particular 200 to 1100 μm. In one preferred embodiment, the overall layer thickness of the multilayer film according to the invention amounts to at least 210 μm, 220 μm, 230 μm, 240 μm, 250 μm, 275 μm, 300 μm, 325 μm, 350 μm, 375 μm, 400 μm, 425 μm, 450 mm, 475 μm, 500 μm, 525 μm, 550 μm, 575 μm or at least 600 μm.

The film according to the invention preferably comprises a heat-sealing layer (S) which is provided with antifogging properties. The heat-sealing layer preferably contains either an additive with antifogging properties or the heat-sealing layer (S) is coated on its free surface with an additive with antifogging properties. If the heat-sealing layer (S) is coated on its free surface with the additive, this coating should he regarded as such and not as an independent layer of the film according to the invention. The beat-sealing layer (S) is preferably of multilayer structure. The additives with antifogging properties are preferably approved for the production of layers which come into contact with foodstuffs.

For the purposes of the description, “heat-sealing layer (S)” or “(S)” should always be taken to mean a layer which contains an additive with antifogging properties or which is coated on its free surface with an additive with antifogging properties.

The additive with antifogging properties preferably comprises an amphiphilic compound. Amphiphilic compounds have the characteristic that they exhibit both lipophilic and hydrophilic properties. The amphiphilic compound preferably comprises a surfactant, in particular a nonionic, anionic, cationic or amphoteric surfactant. Such compounds are known to a person skilled in the art. Reference may be made in this connection, for example, to H. P. Fiedler, Lexikon der Hilfsstoffe für Pharmazie, Kosmetik und angrenzende Gebiete, Editio Cantor Aulendorff, 2002.

In a preferred embodiment the amphiphilic compound is

a nonionic surfactant selected from the group consisting of fatty alcohols, sterols, polyoxyethylene fatty acid esters, polyoxypropylene fatty acid esters, alkylpolyglycosides, alkylphenol ethoxylates and propoxylates, sorbitan fatty acid esters, polyoxyethylene and polyoxypropylene sorbitan fatty acid esters, polyoxyethylene and polyoxypropylene fatty acid glycerides, polyoxyethylene and polyoxypropylene fatty alcohol ethers, glycerol fatty acid mono-, di- and tri-esters and poloxamers;

an anionic surfactant selected from the group consisting of fatty acid salts, salts of alkylsulfonic or alkylarylsulfonic acids and salts of alkylsulfates or alkylarylsulfates; or

a quaternary ammonium compound.

For the purposes of the description, “fatty acids” are linear or branched monocarboxylic acids with 4 to 32 carbon atoms, preferably 12 to 24 carbon atoms, in particular 14, 16 or 18 carbon atoms, which may comprise 1, 2, 3, 4 or 5 olefinic, conjugated or unconjugated double bonds which may mutually independently have cis or trans configuration. The carbon atoms may furthermore be substituted with 1, 2 or 3 hydroxyl groups. The fatty acids are preferably selected from the group consisting of

saturated carboxylic acids, such as for example butyric acid, caproic acid, caprylic acid, capric acid, lauric acid, myristic acid, palmitic acid, stearic acid, arachidic acid, behenic acid and lignoceric acid;

monounsaturated carboxylic acids, such as for example palmitoleic acid, oleic acid, elaidic acid, cis-vaccenic acid, erucic acid and nervonic acid; polyunsaturated carboxylic acids, such as for example linoleic acid, α-linolenic acid, 65 -linolenic acid, di-homo-γ-linolenic acid and arachidonic acid;

unsaturated hydroxycarboxylic acids, such as for example ricinoleic acid; and

saturated hydroxycarboxylic acids, such as for example hydroxystearic acid, in particular 12-hydroxystearic acid.

For the purposes of the description “fatty alcohols” are derived from the above defined fatty acids by the carboxylic acid group being reduced to a hydroxymethyl group.

Fatty alcohols and sterols which are preferred according to the invention are cetyl alcohol, stearyl alcohol, cetylstearyl alcohol and cholesterol.

Sorbitan fatty acid esters which are preferred according to the invention are not only sorbitan fatty acid monoesters such as for example sorbitan monooleate, sorbitan monopalmitate, sorbitan monostearate and sorbitan monolaurate, but also sorbitan fatty acid diesters and sorbitan fatty acid triesters, such as for example sorbitan trioleate and sorbitan tristearate.

Polyoxyethylene sorbitan fatty acid esters which are preferred according to the invention are polysorbate 20, polysorbate 40, polysorbate 60 and polysorbate 80.

Polyoxyethylene fatty acid glycerides which are preferred according to the invention are not only macrogol-1000 glycerol monofatty acid esters such as for example macrogol-1000 glycerol monolaurate, macrogol-1000 glycerol monostearate and macrogol-1000 glycerol monooleate, but also those such as macrogol-1500 glycerol triricinoleate (polyoxyl 35 castor oil) and macrogol glycerol hydroxystearate (polyoxyl 40 hydrogenated castor oil).

Polyoxyethylene fatty acid esters which are preferred according to the invention are macrogol stearate 400, polyoxyl 40 stearate and polyoxyl 50 stearate.

Polyoxyethylene fatty alcohol ethers which are preferred according to the invention are macrogol lauryl ether, polyoxyethylene (23) lauryl ether, polyoxyl 20 cetostearyl ether and polyoxyl 10 oleyl ether.

Glycerol fatty acid esters which are preferred according to the invention are glycerol monostearate and glycerol monooleate.

Poloxamers which are preferred according to the invention are poloxamer 188 and poloxamer 407.

Fatty acid salts which are preferred according to the invention are the ammonium and alkali metal salts of fatty acids, in particular the ammonium, sodium or potassium salts of lauric acid, myristic acid, stearic acid or oleic acid.

Salts of alkylsulfonic acids or alkylsulfates which are preferred according to the invention comprise linear or branched alkyl chains with 8 to 32 carbon atoms, preferably 12 to 24 carbon atoms, in particular 14, 16 or 18 carbon atoms and are ammonium or alkali metal salts.

Salts of alkylarylsulfonic acids which are preferred according to the invention are derived from benzenesulfonic acid and bear, preferably in para position, a linear or branched alkyl chain with 8 to 32 carbon atoms, preferably 12 to 24 carbon atoms, in particular 14, 16 or 18 carbon atoms. The salts are preferably ammonium or alkali metal salts.

Salts of alkylarylsulfates which are preferred according to the invention are derived from phenylsulfate and bear, preferably in para position, a linear or branched alkyl chain with 8 to 32 carbon atoms, preferably 12 to 24 carbon atoms, in particular 14, 16 or 18 carbon atoms. The salts are preferably ammonium or alkali metal salts.

Quaternary ammonium compounds which are preferred according to the invention are benzalkonium chloride, cetylpyridinium chloride, cetyltrimethylammonium compounds and dequalinium chloride.

The additive with antifogging properties may contain one or more of the above-stated amphiphilic compounds. Such additives are commercially obtainable. One particularly preferred additive which is preferably contained in the heat-sealing layer (S) is Schulman Polybatch AF 1088. One particularly preferred additive which is suitable for coating the free surface of the heat-scaling layer (S) is Siegwerk antifogging solution DFC 15-029331-4. If the additive with antifogging properties is contained in the heat-sealing layer (S), the proportion thereof by weight preferably amounts to 0.005 to 25 wt. %, more preferably 0.01 to 20 wt. %, still more preferably 0.05 to 15 wt. %, most preferably 0.1 to 10 wt. % and in particular 0.5 to 5.0 wt. % relative to the total weight of the heat-sealing layer (S). If the free surface of the heat-sealing layer (S) is coated with the additive with antifogging properties, the applied quantity preferably amounts to 0.005 to 5.0 g/m², more preferably 0.01 to 2.0 g/m², still more preferably 0.05 to 1.5 g/m², most preferably 0.1 to 1.0 g/m² and in particular 0.12 to 0.6 g/m² relative to the outer surface of the heat-sealing layer (S).

A person skilled in the art is aware of suitable measures for coating the heat-sealing layer (S). The additive with antifogging properties may, for example, be provided as a coating material and sprayed onto the free surface of the heat-sealing layer (S). Such a coating material is preferably based on acrylic polymers and contains the additive in a quantity of 1 to 20 wt. %, more preferably 2 to 10 wt. %.

The optionally present heat-sealing layer (S) of the film according to the invention is preferably based on at least one polymer selected from the group comprising polyolefins and olefin copolymers. The polymers used for the production of the heat-sealing layer (S) are those approved for the production of layers which come into contact with foodstuffs. In a preferred embodiment, the heat-sealing layer (S) is based on at least one polyolefin selected from the group comprising m-polyethylene (m-PE), high density polyethylene (HDPE), low density polyethylene (LDPE), linear low density polyethylene (LLDPE), acrylic acid copolymer, in particular ionomer (preferably Surlyn®, for example with zinc ions), polypropylene (PP) and propylene copolymer. Particularly preferably, the heat-sealing layer (S) is based on m-PE, LDPE or a mixture thereof. Sealing temperatures preferably lie in the range from 100° C. to 140° C. The melting temperature of the heat-sealing layer (S) amounts preferably to from 90 to 140° C., particularly preferably 95° C. to 130° C. The heat-sealing layer (S) may be provided with conventional auxiliary substances such as antistatic agents, slip agents, processing aids, antiblocking agents and/or spacers.

The heat-sealing layer (S) preferably has a thickness of from 1.0 to 100 μm, more preferably 2.5 μm to 50 μm, still more preferably 5.0 to 25 μm, most preferably 10 to 20 μm and in particular of from 12.5 to 17.5 μm.

The optionally present backing layer (T), the optionally present bonding layer (V) and the optionally present interlayer (Z) are preferably mutually independently based on a thermoplastic polymer, more preferably on a polymer selected from the group consisting of polyamides, copolyamides, polyolefins, olefin copolymers, polystyrene (PS), polyethylene terephthalate (APET or CPET) or polyvinyl chloride.

The optionally present backing layer (T) of the film according to the invention is based on a thermoplastic polymer. A thermoplastic polymer which exhibits a melting temperature of <170° C., preferably of <160° C., very particularly preferably of 110° C. to 170° C., is particularly preferred. The backing layer (T) is preferably based on at least one thermoplastic polymer which is at least one polymer selected from the group comprising polyamides, copolyamides, polyolefins, olefin copolymers, polystyrene (PS), polyethylene terephthalate (APET or CPET) or polyvinyl chloride. The backing layer (T) is particularly preferably based on an aliphatic polyamide or copolyamide, a polyethylene, very particularly preferably polyethylene with a density of <0.92 g/cm³, a polypropylene (PP), an ethylene copolymer, very particularly preferably an ethylene/vinyl acetate copolymer and/or a propylene copolymer. Suitable aliphatic polyamides are in particular polyamide 6 and the copolyamides thereof. It is particularly preferably based on polypropylene or a propylene copolymer.

The optionally present backing layer (T) preferably has a thickness of from 100 to 800 μm, more preferably 150 to 700 μm, still more preferably 175 to 600 μm, most preferably 200 to 300 μm and in particular of from 225 to 275 μm.

The optionally present bonding layer (V) and the optionally present interlayer (Z) of the film according to the invention are preferably independently based on a polymer selected from the group consisting of polyamides, copolyamides, polyolefins, olefin copolymers, polystyrene (PS), polyethylene terephthalate (APET or CPET) or polyvinyl chloride. The optionally present interlayer (Z) and the optionally present bonding layer (V) are particularly preferably mutually independently based on polypropylene or a propylene copolymer, in particular on a propylene random or block copolymer.

The optionally present bonding layer (Z) preferably has a thickness of from 50 to 750 μm, more preferably 100 to 500 μm, still more preferably 125 to 475 μm, most preferably 150 to 450 μm and in particular of from 175 to 425 μm.

The optionally present interlayer (Z) preferably has a thickness of from 0.1 to 100 μm, more preferably 0.5 to 50 μm, still more preferably 1.0 to 25 μm, most preferably 2.5 to 20 μm and in particular of from 5.0 to 15 μm.

In a preferred embodiment, the film according to the invention comprises a backing layer (T), an interlayer (Z) and a bonding layer (V) which are based, identically or differently, on a thermoplastic polyolefin, a thermoplastic olefin copolymer or mixture thereof, particularly preferably on polypropylene or a propylene copolymer. It has surprisingly been found that the thermoformability of the multilayer films according to the invention may be varied over a wide range by means of the melt flow index of the polymers on which the backing layer (T), the interlayer (Z) and the bonding layer (V) are based. The thermoforming temperature may also be varied in this way. The polymers on which the backing layer (T), the interlayer (Z) and the bonding layer (V) are based may be characterised by means of their melt flow rate MFR, which is measured according to the invention preferably to DIN ISO 1133 at 190° C. and 2.16 kg. The polymers on which the backing layer (T), the interlayer (Z) and the bonding layer (V) are based are preferably polymers with a comparatively high MFR, i.e. low viscosity. Preferably, the backing layer (T) is based on a polymer which has a lower melt flow rate than the polymer on which the interlayer (Z) is based. Preferably, the backing layer (T) is based on a polymer which has a lower melt flow rate than the polymer on which the bonding layer (V) is based.

Particularly preferably, the melt flow rates of the polymers on which the layers (T), (Z) and (V) are based behave according to the following sequence:

MFR(T)<MFR(Z)<MFR(V) or

MFR(T)<MFR(V)<MFR(Z),

wherein the melt flow rates MFR are in each case determined to DIN ISO 1133 at 190° C. and 2.16 kg.

In a preferred embodiment, the ratio of the melt flow rate of the polymer on which tile backing layer (T) is based (MFR(T)) to the melt flow rate of the polymer on which the interlayer (Z) is based (MFR(Z)) is in the range from 1:1.1 to 1:20, more preferably 1:1.2 to 1:10, still more preferably 1:1.3 to 1:5, most preferably 1:1.4 to 1:4 and in particular 1:1.5 to 1:3, wherein the melt flow rates MFR are in each case determined to DIN ISO 1133 at 190° C. and 2.16 kg.

In a preferred embodiment, the ratio of the melt flow rate of the polymer on which the backing layer (T) is based (MFR(T)) to the melt flow rate of the polymer on which the bonding layer (V) is based (MFR(V)) is in the range from 1:1.1 to 1:20, more preferably 1:1.2 to 1:10, still more preferably 1:1.3 to 1:5, most preferably 1:1.4 to 1:4 and in particular 1:1.5 to 1:3, wherein the melt flow rates MFR are in each case determined to DIN ISO 1133 at 190° C. and 2.16 kg.

It has surprisingly been found that the optical properties of the multilayer films according to the invention are improved in comparison with multilayer films which, although they contain a backing layer (T), contain no interlayer (Z) and no bonding layer (V). If, in particular, the multilayer films according to the invention are transparent, thermoforming has no or only an insignificant negative influence on transparency (relative to a constant material thickness, i.e. taking account of the thinning of the packaging material in the course of deformation).

The optionally present barrier layer (B) of the film according to the invention is preferably gas- and/or aroma-tight and is preferably based on at least one polymer selected from the group comprising ethylene/vinyl alcohol copolymer, vinylidene chloride copolymer, polyester and polyamide, preferably on ethylene/vinyl alcohol copolymer (EVOH). The optionally present barrier layer (B) needs to be largely impermeable both to oxygen and to water vapour. This property preferably also needs to be maintained even if the film is used at elevated temperatures. If ethylene/vinyl alcohol copolymer has been obtained by partial saponification of an ethylene/vinyl acetate copolymer, the degree of saponification is preferably between 25 and 50 mol %, more preferably between 35 and 45 mol %. Preferably, the gas-tightness of the film according to the invention, determined to DIN 53380, amounts to less than 5.0, more preferably less than 4.0 and in particular less than 2.0 [cm³/m² d bar O₂].

The optionally present barrier layer (B) preferably has a thickness of from 0.5 to 50 μm, more preferably 1.0 to 40 μm, still more preferably 1.5 to 30 μm, most preferably 2.0 to 10 μm and in particular of from 2.5 to 7.5 μm.

The optionally present coupling agent layers (HV-1) and (HV-2) of the film according to the invention are preferably mutually independently based on a mixture of polyolefins and/or olefin copolymer, preferably selected from the group consisting of LDPE, HDPE, PP, maleic anhydride copolymer (MAH copolymer) and/or ethylene/vinyl acetate copolymer. Preference is given to anhydride-modified polyethylene, acid copolymers of ethylene, acid-modified ethylene vinyl acetate, acid-modified ethylene (meth)acrylate, anhydride-modified ethylene (meth)acrylate, anhydride-modified ethylene vinyl acetate, acid-/acrylate-modified ethylene vinyl acetate and a polymer blend containing at least one of the above-stated polymers. MAH copolymers are particularly preferred.

The optionally present coupling agent layers (HV-1) and/or (HV-2) preferably mutually independently exhibit a thickness of from 0.1 to 25 μm, more preferably 0.2 to 15 μm, still more preferably 0.5 to 10 μm, most preferably 1.0 to 7.5 μm and in particular of from 2.0 to 5.0 μm.

The optionally present polyamide layers (PA-1) and/or (PA-2) of the multilayer film according to the invention are preferably mutually independently based on a polyamide or copolyamide, which may be aliphatic or (partly) aromatic. The polyamide is preferably aliphatic. In a preferred embodiment of the film according to the invention, the polyamide layer (PA-1) and/or the polyamide layer (PA-2) are based mutually independently on a polyamide or copolyamide selected from the group consisting of PA 4, PA 6, PA 7, PA 8, PA 9, PA 10, PA 11, PA 12, PA 4.2, PA 6.6, PA 6.8, PA 6.9, PA 610, PA 6.12, PA 7.7, PA 8.8, PA 9.9, PA 10.9, PA 12.12, PA 6/6.6, PA 6.6/6, PA 6.2/6.2, and PA 6.6/6.9/6. Preferably, the composition of the polyamide layer (PA-1) and the polyamide layer (PA-2) is identical. PA 6 is particularly preferred.

The optionally present polyamide layer (PA-1) and the optionally present polyamide layer (PA-2) preferably mutually independently exhibit a thickness of from 0.1 to 25 μm, more preferably 0.2 to 15 μm, still more preferably 0.5 to 10 μm, most preferably 1.0 to 7.5 μm and in particular of from 2.0 to 5.0 μm.

The ratio of the sum of layer thicknesses of the backing layer (T), the optionally present bonding layer (V) and the optionally present interlayer (Z) to the sum of the layer thicknesses of the optionally present coupling agent layer (HV), the optionally present polyamide layer (PA-1), the optionally present barrier layer (B), the optionally present polyamide layer (PA-2) and the heat-sealing layer (S) is preferably in the range from 2:1 to 500:1, more preferably 5:1 to 250:1, still more preferably 10:1 to 50:1, most preferably 10:1 to 25:1 and in particular 10:1 to 22.5:1.

Particularly preferred embodiments of the film according to the invention are summarised in the following table, wherein the film has the structure

### (T)//(Z)//(V)//(HV-1)//(PA-1)//(B)//(PA-2)//(HV-2)//(S) or

### (T)//(V)//(Z)//(HV-1)//(PA-1)//(B)//(PA-2)//(HV-2)//(S):

| | | Layer thickness | | |
|---|---|---|---|---|
| | Composition | | more | |
| Layer | comprising | preferably | preferably | in particular |
| (T) | Polypropylene and/or | 100-500 μm | 175-325 μm | 225-275 μm |
| | propylene copolymer | | | |
| (V) | Polypropylene and/or | 50-750 μm | 125-475 μm | 175-425 μm |
| | propylene copolymer | | | |
| (Z) | Polypropylene and/or | 0.1-100 μm | 1.0-25 μm | 5.0-15 μm |
| | propylene copolymer | | | |
| (HV-1) | Suitable coupling | 0.1-25 μm | 0.5-10 μm | 2.0-5.0 μm |
| | agent | | | |
| (PA-1) | Polyamide or | 0.1-25 μm | 0.5-10 μm | 2.0-5.0 μm |
| | copolyamide | | | |
| (B) | Ethylene/vinyl acetate | 0.5-50 μm | 1.5-30 μm | 2.5-7.5 μm |
| | copolymer | | | |
| (PA-2) | Polyamide or | 0.1-25 μm | 0.5-10 μm | 2.0-5.0 μm |
| | copolyamide | | | |
| (HV-2) | Suitable coupling | 0.1-25 μm | 0.5-10 μm | 2.0-5.0 μm |
| | agent | | | |
| (S) | Polyethylene and/or | 1.0-100 μm | 5.0-25 μm | 12.5-17.5 μm |
| | ethylene copolymer | | | |

The film according to the invention may comprise further layers based on at least one polymer selected from the group comprising polyolefins, olefin copolymers, polyesters, polyamides, polystyrene (PS), polyethylene terephthalate (APET or CPET) or polyvinyl chloride.

The film according to the invention may be printed, wherein at least one layer of the film may be printed or coloured by the addition of additives such as organic or inorganic dyes and pigments, wherein as a consequence transparency should not be impaired or only insignificantly so.

The film according to the invention is thermoformable. To assess the mechanical properties of the film according to the invention, it is possible, for example, to determine the secant modulus, 5% offset yield stress and tensile stress at yield (yield point) by means of the tensile test to DIN 53 455. In this context, the secant modulus is the slope of the stress-strain curve between 0.05 and 0.25% extension relative to the clamping cross-section, the 5% offset yield stress is the stress at 5% extension and the tensile stress at yield is the tensile stress at which the slope of the stress-strain curve becomes equal to zero for the first time. Samples 15 mm in width are investigated at 23° C., 50% relative atmospheric humidity and a test speed of 100 mm/min.

Preferably, the secant modulus determined using the above-stated method amounts to at least 650 N/mm², more preferably at least 700 N/mm², still more preferably at least 720 N/mm², most preferably at least 750 N/mm² and in particular at least 780 N/mm². In a preferred embodiment of the film according to the invention, the secant modulus amounts to at least 800 N/mm², more preferably at least 900 N/mm², still more preferably at least 1000 N/mm², most preferably it is in the range from 800 to 1500 N/mm², in particular from 1000 to 1200 N/mm². The secant modulus particularly preferably amounts to the above-stated values at a temperature of 100° C. The secant modulus correlates with the rigidity of a packaging tray. Preferably, a packaging tray may be thermoformed from the film according to the invention which tray, when heated, i.e. at 100° C., still exhibits sufficient mechanical stability for it already to exhibit significant rigidity (expressed by means of the secant modulus) when still heated.

Preferably, the 5% offset yield stress determined using the above-stated method amounts to at least 10 N/mm², more preferably at least 13 N/mm², still more preferably at least 16 N/mm², most preferably at least 19 N/mm² and in particular at least 21 N/mm². In a preferred embodiment of the film according to the invention, the 5% offset yield stress amounts to at least 22 N/mm², more preferably at least 25 N/mm², still more preferably at least 30 N/mm², most preferably it is in the range from 25 to 50 N/mm², in particular from 30 to 40 N/mm².

Preferably, the yield point determined using the above-stated method amounts to at least 15 N/mm², more preferably at least 20 N/mm², still more preferably at least 22 N/mm², most preferably at least 24 N/mm² and in particular at least 26 N/mm². In a preferred embodiment of the film according to the invention, the yield point amounts to at least 30 N/mm², more preferably at least 35 N/mm², still more preferably at least 40 N/mm², most preferably it is in the range from 35 to 60 N/mm², in particular from 40 to 50 N/mm².

In a preferred embodiment, the films according to the invention have a tensile modulus in the range from 1000 to 2500 MPa, more preferably 1050 to 2200 MPa, still more preferably 1100 to 1900 MPa, most preferably 1150 to 1700 MPa and in particular 1200 to 1500 MPa. The tensile modulus is preferably determined to ASTM test standard D638 (ISO 527).

In preferred embodiments 1-5, the film according to the invention, preferably in both the lengthwise and crosswise directions, exhibits one or more of the following parameters measured by tensile test to DIN EN ISO 527-3, preferably at least a secant modulus Eₛ within one of the following listed value ranges (mean calculated from three measurements; force transducer Fₘₐₓ: 2.5 kN; position sensor: crosshead; clamping length: 100 mm; a₀: in the range from 0.018-0.068 mm; b₀: 15 mm; S₀: in the range from 0.27-1.02 mm²; preliminary force: 0.1 MPa; test speed 500 mm/min; start of E-modulus determination: 0.25%; end of E-modulus determination: 1.5%):

| Parameter | 1 | 2 | 3 | 4 | 5 |
|---|---|---|---|---|---|
| Eₛ [N/mm²] | 650-1600 | 750-1300 | 860-1060 | 880-1030 | 900-1000 |
| σ_{γ} [MPa] | 150-350 | 170-300 | 190-280 | 210-260 | 220-250 |
| ε_{γ} [%] | 5.0-15 | 6.5-13 | 7.9-11.5 | 9.5-10.5 | 9.0-10 |
| σ_{M} [MPa] | 240-410 | 260-390 | 280-370 | 290-360 | 300-350 |
| ε_{M} [%] | 480-750 | 500-720 | 520-700 | 540-680 | 560-660 |
| σ_{B}[MPa] | 90-400 | 100-380 | 110-370 | 130-350 | 150-300 |
| ε_{B} [%] | 350-800 | 400-750 | 450-700 | 500-650 | 550-600 |

Eₛ Secant modulus to DIN EN ISO 527-3
σ_{γ}/ε_{γ} stress/strain in the linear range to DIN EN ISO 527-3
σ_{M}/ε_{M} stress/strain in the max. range to DIN EN ISO 527-3
σ_{B}/ε_{B} stress/strain at break to DIN EN ISO 527-3

Preferably, at least one of the pairs of parameters (σ_{γ}/ε_{γ}, σ_{M}/ε_{M} or σ_{B}/ε_{B} is within the stated value ranges. Particularly preferably, all the parameters lie within the stated value ranges.

Preferably, the film according to the invention is suitable to be thermoformed by a thermoforming ratio of 1:2, more preferably 1:2.5, still more preferably 1:3, still more preferably 1:3.5, most preferably 1:4 and in particular 1:4.5. It is known to a person skilled in the art that the individual layer thickness of the multilayer film may be adapted to the intended thermoforming ratio, so that the material thickness is still sufficient afterwards even in the thermoformed areas.

In principle, the film according to the invention may additionally contain conventional additional or auxiliary substances independently in one or more layers. In order to modify the surface slip properties of the film, at least one layer may contain slip agents and/or anti-blocking agents. Anti-blocking agents should here preferably be present in the backing layer (T) and/or the heat-sealing layer (S), but preferably not in one of the layers located therebetween. Slip agents may preferably also be present at least in one of the optionally present interlayers. In addition, the film may contain conventional stabilisers, antioxidants, plasticisers, processing aids, UV absorbers, fillers, flame retardants, antistatic agents, etc. in one or more layers. Such substances are known to a person skilled in the art.

The film according to the invention may be produced by a blowing, flat film, coating, extrusion, coextrusion or a corresponding coating or laminating process. Combinations of these processes are also possible.

The film according to the invention may be produced by the film blowing/coextrusion process, as is for example described in U.S. Pat. No. 3,456,044. In particular if the film according to the invention contains more than 4 layers, it is preferred initially to produce separate elements from for example 2 or 3 layers by (co)extrusion and then to join said elements together. For example, the sequence of layers (B)//(S) and the sequence of layers (T)//(Z)//(V) or (T)//(V)//(Z) may be produced separately from one another and then laminated to one another. Such processes are known to a person skilled in the art. In this connection, reference may be made for example to A. L. Brody, K. S. Marsh, The Wiley Encyclopedia of Packaging Technology, Wiley-Interscience, 2nd edition (1997); W. Soroka,

Fundamentals of Packaging Technology, Institute of Packaging Professionals (1995); J. Nentwig, Kunststoff-Folien, Hanser Fachbuch (2000); and S. E. M. Selke, Understanding Plastics Packaging Technology (Hanser Understanding Books), Hanser Gardner Publications (1997).

According to the invention, production of the multilayer films is preferably effected by a consecutive process, in which first of all a multilayer film is produced, which comprises only some of the layers of the multilayer film according to the invention. This multilayer film preferably comprises an interlayer (Z), a barrier layer (B) and a heat-sealing layer (S), but neither a backing layer (T) nor a bonding layer (V). The multilayer film produced in this way is then bonded, in accordance with the invention in the manner of extrusion lamination, to the backing layer (T) by extrusion of the bonding layer (V).

Preferably, one or all the layers of the film according to the invention are crosslinked before or after orientation in order to increase their repulsive force and/or puncture resistance. Crosslinking preferably proceeds by using β radiation. An electron beam generator operating in a range from 150 kV to 300 kV is used as the irradiation source. A dose of 60 kGy is preferably provided for irradiation in order to crosslink the entire film or also only individual layers, such as for example the outer layer.

The polymers used for the layer structure of the film are commercially obtainable and described sufficiently in the prior art. To produce films according to the invention, they are conventionally mixed in the form of pellets or granules so far as is necessary in conventional mixers and further processed by melting preferably with the assistance of extruders. As already explained, production by the film blowing/coextrusion process is preferred, wherein the extruders used are those with coextruder dies. The processing temperatures, in particular those during extrusion, are known to the person skilled in the art.

Known production installations conventional in the art may be considered. In the case of flat film coextrusion, “chill roll” installations are used, the particular feature of which is large chill rolls which receive the molten film leaving the die.

The film according to the invention is outstandingly suitable for packaging of products, preferably foodstuffs, particularly preferably perishable foodstuffs, which have a water content of at least 1 wt. %, more preferably at least 2 wt. %, still more preferably at least 5 wt. %, most preferably at least 7.5 wt. % and in particular at least 10 wt. %. The film may be used both for hot-fill applications and for heating package contents in the film proceeding as far as sterilisation. The film is suitable for the packaging of foodstuffs such as meat, fish, vegetables, fruit, milk products, smoked goods, ready meals, grain, cereals, bread and bakery products, and also of other goods, such as for example medical products.

A further aspect of the present invention accordingly relates to packaging made from the film according to the invention, preferably for foodstuffs, particularly preferably perishable foodstuffs.

The packaging according to the invention comprises two packaging elements, wherein the first packaging element comprises a transparent film as defined above, which is thermoformed, and the second packaging element comprises a multilayer film with an overall layer thickness of less than 250 μm, more preferably less than 200 μm, still more preferably less than 100 μm, most preferably less than 75 μm and in particular less than 50 μm.

The multilayer film making up the second packaging element is preferably not thermoformable.

In a preferred embodiment, the second packaging element comprises a transparent multilayer film which is likewise is provided with antifogging properties. To this end, it may contain an additive with antifogging properties as described above or be coated such an additive on the surface which faces towards the packaged product.

The additive with antifogging properties preferably comprises one of the above-described compositions, which may be identical or different in comparison with the additive with antifogging properties which is contained in the thermoformed film according to the invention or is present as a coating.

Preferably, the first packaging element comprises a tray, which has been shaped by thermoforming, a cavity being formed between the first and the second packaging elements, wherein the first and second packaging elements are sealed together at the edges.

In a preferred embodiment of the packaging according to the invention, the ratio of the overall layer thickness of the first packaging element to the overall layer thickness of the second packaging element is in the range from 200:1 to 1:1, more preferably 100:1 to 2:1, still more preferably 50:1 to 3:1, most preferably 25:1 to 4:1 and in particular 20:1 to 5:1.

A further aspect of the invention relates to the use of a film as described above or of a packaging as described above for packaging a moisture-releasing product to be packaged. The moisture-containing product to be packaged is preferably a foodstuff.

The following Example serves to illustrate the invention, but is not limiting.

### EXAMPLE

The following multilayer film was produced by coextrusion:

| Type | Thickness | Polymer |
|---|---|---|
| (T) | 250 μm | Polypropylene |
| (V) | 190 μm | Propylene copolymer |
| (Z) | 9 μm | Propylene copolymer |
| (HV-1) | 10 μm | Olefin copolymer with grafted maleic anhydride |
| (PA-1) | 15 μm | Polyamide 6 |
| (B) | 30 μm | Ethylene/vinyl alcohol copolymer (38 mol |
| | | % EVOH) |
| (PA-2) | 15 μm | Polyamide 6 |
| (HV-2) | 10 μm | Olefin copolymer with grafted maleic anhydride |
| (S) | 20 μm | LDPE with 10 wt. % additive with antifogging |
| | | properties, 2 wt. % anti-blocking agent, |
| | | 1 wt. % further auxiliary substances |

“Polybatch AF 1088” from Schulman was used as the additive with antifogging properties.

1. A transparent, thermoformable film comprising a backing layer (T), an interlayer (Z) and a bonding layer (V), the composition of each layer being the same or different and each being formed of a thermoplastic polyolefin, a thermoplastic olefin copolymer or a mixture thereof, wherein the film is provided with antifogging properties.

2. A film according to claim 2, wherein the melt flow rates of the polymers of which the layers (T), (Z) and (V) are formed behave according to the following sequence:
MFR(T)<MFR(Z)<MFR(V) or
MFR(T)<MFR(V)<MFR(Z).

3. A film according to claim 1 further comprising an outer heat-sealing layer (S), wherein the heat-sealing layer (S) either contains an additive with antifogging properties or is coated on its free surface with an additive with antifogging properties.

4. A film according to claim 3, comprising 1 to 5 layers mutually independently selected from the group consisting of a coupling agent layer (HV-1), a first polyamide layer (PA-1), a barrier layer (B), a second polyamide layer (PA-2) and a coupling agent layer (HV-2), between the backing layer (T) and the heat-sealing layer (S).

5. A film according to claim 3 wherein the additive with antifogging properties comprises an amphiphilic compound.

6. A film according to claim 5, wherein the amphiphilic compound is
a nonionic surfactant selected from the group consisting of fatty alcohols, sterols, polyoxyethylene fatty acid esters, polyoxypropylene fatty acid esters, alkylpolyglycosides, alkylphenol ethoxylates and propoxylates, sorbitan fatty acid esters, polyoxyethylene and polyoxypropylene sorbitan fatty acid esters, polyoxyethylene and polyoxypropylene fatty acid glycerides, polyoxyethylene and polyoxypropylene fatty alcohol ethers, glycerol fatty acid mono-, di- and tri-esters and poloxamers;
an anionic surfactant selected from the group consisting of fatty acid salts, salts of alkylsulfonic or alkylarylsulfonic acids and salts of alkylsulfates or alkylarylsulfates; or
a quaternary ammonium compound.

7. A film according to claim 1, comprising an overall layer thickness in the range of from 100 to 3000 μm.

8. A film according to claim 1, wherein the heat-sealing layer (S) is formed of a polymer selected from the group consisting of polyolefins and olefin copolymers.

9. A film according to claim 4, wherein the first polyamide layer (PA-1) or the second polyamide layer (PA-2) independently formed of a polyamide or copolyamide selected from the group consisting of
PA 4, PA 6, PA 7, PA 8, PA 9, PA 10, PA 11, PA 12, PA 4.2, PA 6.6, PA 6.8,
PA 6.9, PA 6.10, PA 6.12, PA 7.7, PA 8.8, PA 9.9, PA 10.9, PA 12.12, PA 6/6.6,
PA 6.6/6, PA 6.2/6.2, and PA 6.6/6.9/6.

10. A film according to claim 1, having a secant modulus, determined in accordance with DIN EN ISO 527-3, amounts to at least 650 N/mm².

11. A packaging comprising a thermoformed film of claim 1.

12. A packaging according to claim 11, comprised of two packaging elements, the first of which comprises a transparent thermoformed film of claim 1 and the second of which comprises a multilayer film with an overall layer thickness of less than 250 μm.

13. A packaging according to claim 12, wherein the second packaging element comprises a transparent multilayer film, having an outer layer which faces towards the inside of the packaging and is provided with antifogging properties.

14. A packaging according to claim 12 wherein the ratio of the overall layer thickness of the first packaging element to the overall layer thickness of the second packaging element is in the range from 200:1 to 1:1.

15. A method for packaging a moisture-releasing product, which comprises packaging said moisture-releasinq product in a packaging of claim 11.

16. Method according to claim 15, wherein the moisture-releasing product is a foodstuff.

17. A film according to claim 4 wherein the additive with antifogging properties comprises an amphiphilic compound.

18. A film according to claim 17, wherein the amphiphilic compound is
a nonionic surfactant selected from the group consisting of fatty alcohols, sterols, polyoxyethylene fatty acid esters, polyoxypropylene fatty acid esters, alkylpolyglycosides, alkylphenol ethoxylates and propoxylates, sorbitan fatty acid esters, polyoxyethylene and polyoxypropylene sorbitan fatty acid esters, polyoxyethylene and polyoxypropylene fatty acid glycerides, polyoxyethylene and polyoxypropylene fatty alcohol ethers, glycerol fatty acid mono-, di- and tri-esters and poloxamers;
an anionic surfactant selected from the group consisting of fatty acid salts, salts of alkylsulfonic or alkylarylsulfonic acids and salts of alkylsulfates or alkylarylsulfates; or
a quaternary ammonium compound.
